(19) United States
(12) Patent Application Publication
(10) Pub. No.: US 2015/0158101 A1
(43) Pub. Date: Jun. 11, 2015

(54) THREAD TAP ADAPTER

(71) Applicant: Eliot Evans, Joice, IA (US)

(72) Inventor: Eliot Evans, Joice, IA (US)

(21) Appl. No.: 14/100,846

(22) Filed: Dec. 9, 2013

(51) Int. Cl. B23G 1/46; B23G 1/26

(52) U.S. Cl. CPC B23G 1/46; B23G 1/261

(57) ABSTRACT

A thread tap adapter for interfacing a driving device with a thread tap to assist in the engagement of the driving device to the thread tap. The thread tap adapter having a retention element for engaging the thread tap at a position remote from the drive portion of the thread tap to maintain the engagement of the thread tap adapter to the thread tap. The retention element also provides a secondary transfer point by which the rotational force applied to the thread tap adapter by the driving device is more efficiently transferred to the thread tap. The thread tap adapter can also comprise at least one radially extending flanges for engaging the driving device and prevent the driving device from inadvertently slipping off the adapter by sliding axially along the thread tap adapter.

### FIELD OF THE INVENTION

The present invention relates to the threading holes with a tap. More specifically, the present relates to a thread tap adapter for interfacing conventional thread taps with a driving mechanism.

### BACKGROUND OF THE INVENTION

In the metalworking and fabrication fields, there is an ongoing need to create threads in a hole for rotatably interfacing with corresponding threads of screws, bolts and other rotatably engaged fixation elements. Thread taps comprise a bit portion that is rotatably inserted into a bore hole to cut threads into the walls of the bore hole. As materials secured by screw threads are often hardened materials, the amount of rotational force required to cut the screw treads can be substantial. Accordingly, the existing integrated devices for driving a thread tip into a hole are often large and cumbersome. Some devices for driving a tap, such as T-handle wrenches with a collet-type engagement comprise handle portions as long as the tap itself to provide sufficient leverage in rotating the thread tap. The large size, long rotational arc or simply the cumbersome shape of the driving device can prevent or significantly hamper the use of the tread tap.

Driving devices such as drills, presses, wrenches and other motor or hand driven driving devices are often secured to the thread taps without integrated driving devices. These thread taps typically comprise an engagement portion having a square profile. However, the three-jaw chucks commonly found on hand drills or drill presses are often incompatible with or poorly secure the square profile of the engagement portion. Specifically, the three jaws cannot securely grip the four flat surfaces of the engagement portion of the tap. Similarly, the six point sockets or box wrenches that are often used to manually rotate the thread tap can be incompatible with the square profile of the thread tap. Accordingly, a tap adapter is often employed to provide an interfacing element between the driving device and the thread tap.

U.S. Pat. No. 5,213,347 to Rulon et al. discloses a tap adapter for use with a ratchet that comprises a similar structure to a standard socket and is engagable to a ratchet in the same manner as a conventional socket. However, Rulon does not address the incompatibility between a thread tap with a three-jaw chuck. The outer profile of the Rulon tap adapter is cylindrical and cannot be effectively gripped by a three jaw chuck. Additionally, in situations where little clearance is available proximate the end of the thread tap, the Rulon tap adapter may not be suitable as requiring additional clearance for fitting and engaging the ratchet.

U.S. Pat. No. 5,037,251 to Roth discloses a thread tap comprising a shank having both a traditional square end profile and a hexagonal profile. However, as the multi-profile shank is integrated into the thread tap itself, each conventional tap would necessarily be replaced at great expense. In addition, a hexagonal shank profile alone creates a substantially more complicated and expensive manufacturing process than standard taps. The manufacturing process is further complicated and made more expensive as manufacturing entails both a traditional square shank profile and a hexagonal shank profile. As thread taps are necessary hardened to effectively cut the threads in the bore holes, the thread taps can become brittle and susceptible to damage when dropped. The expensive manufacturing process substantially increases the cost of replacing a damaged or broken thread tap.

Accordingly, there remains a need for applying rotational energy to a thread tap for a non-integrated drive device.

### SUMMARY OF THE INVENTION

The present invention is generally directed to a thread tap adapter for interfacing the engagement features of a driving device with a thread tap for driving rotation of the thread tap with the driving device. Specifically, the thread tap adapter can comprise a central axial bore for receiving the tread tap. The thread tap adapter can also comprise an engagement element positioned within the central axial bore for radially engaging the shank portion of the thread tap to retain the thread tap within the central axial bore. The engagement element can comprise a flexible material deformable to positively engage the shank portion of the thread tap or a rigid element that forms a friction fit with the shank portion of the thread portion. The engagement element provides a tool-less retention element that secures the thread tap within the central axial bore without the aid of a set screw or other element that must be tightened after the thread tap is inserted. In certain embodiments, the retention element provides a secondary support preventing wobble of the thread tap within the axial bore. Similarly, the retention element can operate as a second engagement point by which rotation of the thread tap adapter is translated to the thread tap.

In certain embodiments, a thread tap adapter can further comprise a flange extending from the thread tap adapter body along a plane generally perpendicular to the central rotational axis of the thread tap adapter. The flange defines an alignment surface for preventing axial movement of the engagement features of the driving device along the adapter body thereby reducing the likelihood that the engagement features will inadvertently separate or slip from the thread tap adapter during driving of the thread tap. The flange can also serve as a stop limiting the axial depth of the three-jaw chuck and engagement features that are inserted over the thread tap adapter axially. In certain embodiments, the thread tap adapter can comprise parallel flanges defining opposing alignment faces for further limiting axial movement of the engagement features to between the parallel flanges.

A thread tap adapter, according to an embodiment of the present invention, can comprise an adapter body defining a central axial bore having a drive portion and a shank portion. The drive portion can comprise a square profile or other profile engagable to the corresponding drive portion of thread tap, wherein the driver portion of thread tap adapter prevents rotation of the thread tap adapter relative to the thread tap. Similarly, the shank portion comprises a cylindrical profile or other profile positioned engagable to, but permits rotation of the thread tap adapter around the thread tap. The thread tap adapter further comprises a retention element positioned within the shank portion of the thread tap adapter, wherein the retention element is adapted to engage the shank portion of the thread tap. In certain embodiments, the thread tap adapter can further comprise at least one flange extending radially outward from the thread tap adapter, wherein each flange comprises an alignment surface for guiding the engagement of the driving device to the thread tap adapter.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE FIGURES

The invention can be more completely understood and appreciated by referring to the following more detailed description of the presently preferred exemplary embodiments of the invention in conjunction with the accompanying drawings, of which:

FIG. 1 is a top isometric view of a thread tap adapter, according to an embodiment of the present invention.

FIG. 2 is a bottom isometric view of the thread tap adapter depicted in FIG. 1.

FIG. 3 is a cross-sectional side view of the thread tap adapter depicted in FIG. 1.

FIG. 4 is a top view of the thread tap adapter depicted in FIG. 1.

FIG. 5 is a bottom view of the thread tap adapter depicted in FIG. 1.

FIG. 6 is a cross-sectional side view of a thread tap adapted according to an embodiment of the present invention.

FIG. 7 is a cross-sectional side view of a thread tap adapted according to an embodiment of the present invention.

FIG. 8 is a cross-sectional side view of a thread tap adapted according to an embodiment of the present invention.

FIG. 9 is a front isometric view of a thread tap adapter, according to an embodiment of the present invention, fitted to a representative thread tap.

FIG. 10 is a rear isometric view of the thread tap adapter and thread tap assembly depicted in FIG. 9.

FIG. 11 is a side view is a side view of the thread tap adapter and thread tap assembly depicted in FIG. 9.

FIG. 12 is a side cross-sectional view of the thread tap adapter and thread tap assembly depicted in FIG. 9.

FIG. 13 is a top view of the thread tap adapter and thread tap assembly depicted in FIG. 9.

FIG. 14 is a top isometric view of a thread tap adapter, according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

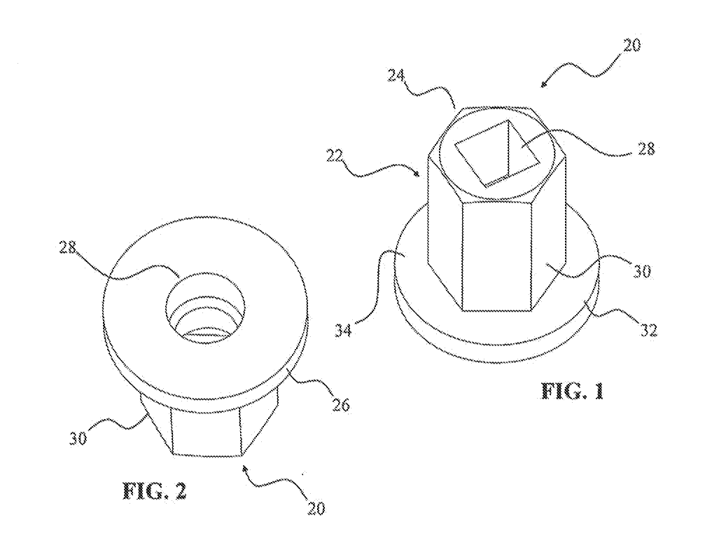

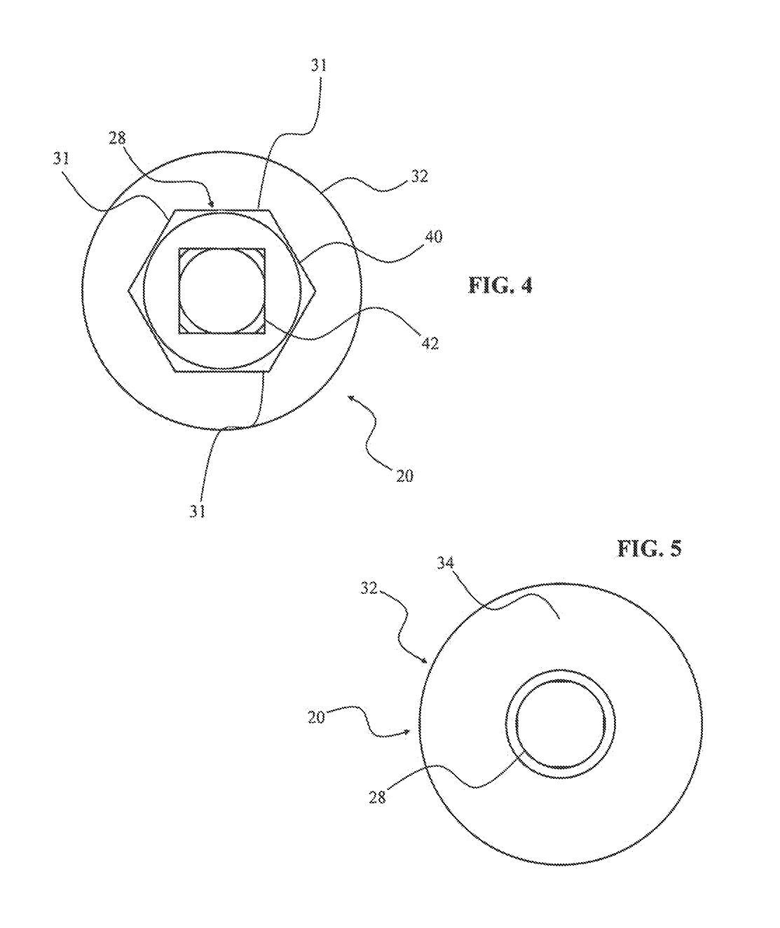

As depicted in FIGS. 1-5, a thread tap adapter 20, according to an embodiment of the present invention, comprises an adapter body 22 having a first end 24 and a second end 26. The adapter body 22 also defines a central axial bore 28 extending from the first end 24 to the second end 26 and defining the central rotational axis of the adapter body 22. Similarly, the adapter body 22 further comprises a multi-faceted external surface 30. The thread tap adapter body 22 can comprise suitable materials of construction such as, for example, cold rolled steel, stainless steel, aluminum and various steel alloys such as, for example, 4140, S7, A2, D2 as well as other suitable materials including but not limited to appropriate plastic polymer and other materials known to those of skill in the art of metals and metal fabrication.

As depicted in FIGS. 1-5, the multi-faceted external surface 30 comprises six individual sides 31 that are engageable by traditional sockets and wrenches, such as, for example, box, crescent and open ended wrenches. In addition, when multi-faceted external surface 30 include six individual sides 31, the multi-faceted external surface 30 can be engaged by conventional three jaw chucks. In certain embodiments, the multi-faceted external surface 30 of the adapter body 22 is sized for use with standard wrench sizes, in either metric or English units.

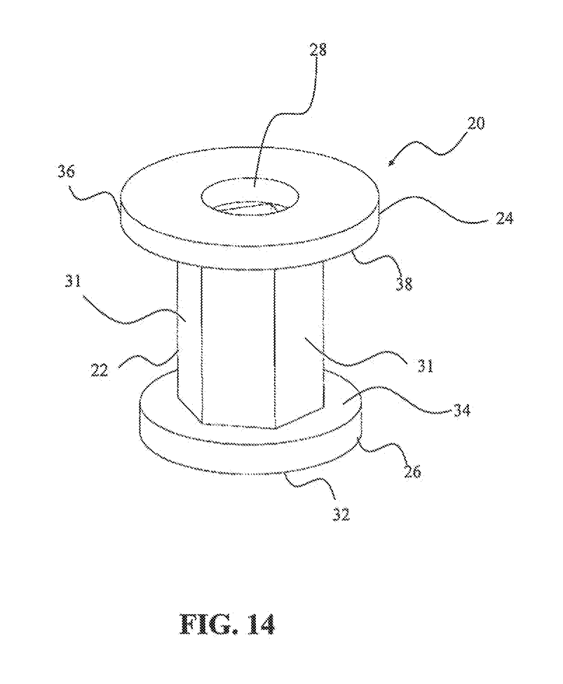

As depicted in FIGS. 1-5, the adapter body 22 further comprises a first flange portion 32 positioned at the second end 26 of the adapter body 22. The flange portion 32 extends radially outward from the central rotational axis of the adapter body 22. The flange portion 32 is sized to define an alignment face 34 defining a plane generally perpendicular to the central rotational axis of the adapter body 22. In another representative embodiment as shown in FIG. 14, the adapter body 22 further comprises a second flange portion 36 defining a second alignment face 38 facing the alignment face 34 of the first flange portion 32.

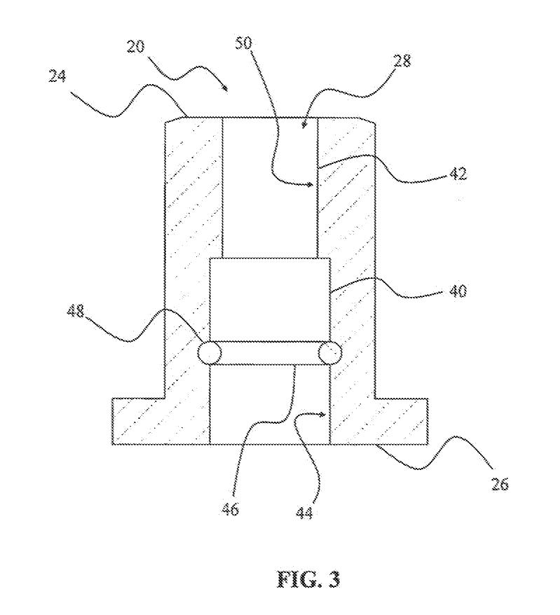

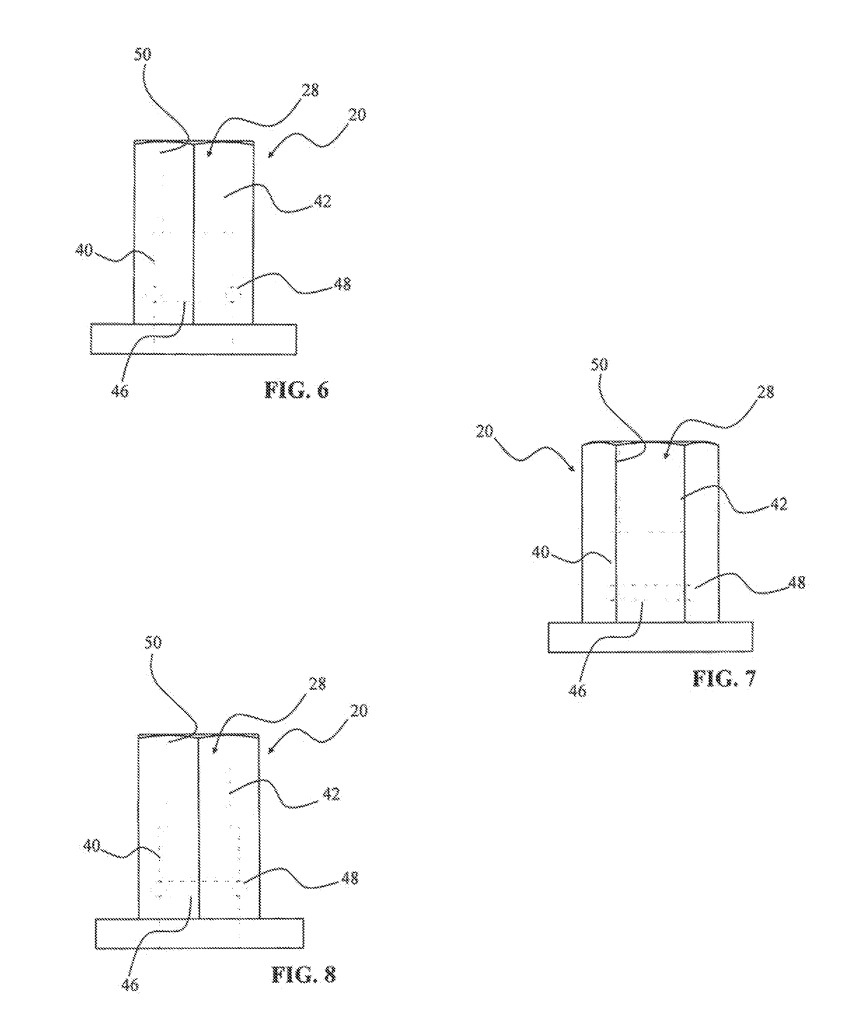

As depicted in FIGS. 3, 4 and 6-8, the central axial bore 28 comprises a shank receiving portion 40 and drive receiving portion 42. As depicted, the shank receiving portion 40 comprises an inner shank surface 44 having a cylindrical profile. In other embodiments, the inner shank surface 44 can comprise hexagonal or other multi-faceted profiles. The shank receiving portion 40 further comprises a retention element 46 positionable within a radial groove 48 in the inner shank surface 44. The retention element 46 extends radially inward from the radial groove 48 into the central axial bore 28. In certain embodiments, the retention element 46 comprises a flexible ring having a rubber or elastomeric construction. In other embodiments, the retention element 46 comprises a rigid ring having a metal or rigid polymer construction and having a contoured or faceted inner edge. As depicted, the drive receiving portion 42 comprises a multi-faceted drive surface 50 having a generally square profile. In other embodiments, the drive surface 50 can comprise other multi-faceted profiles.

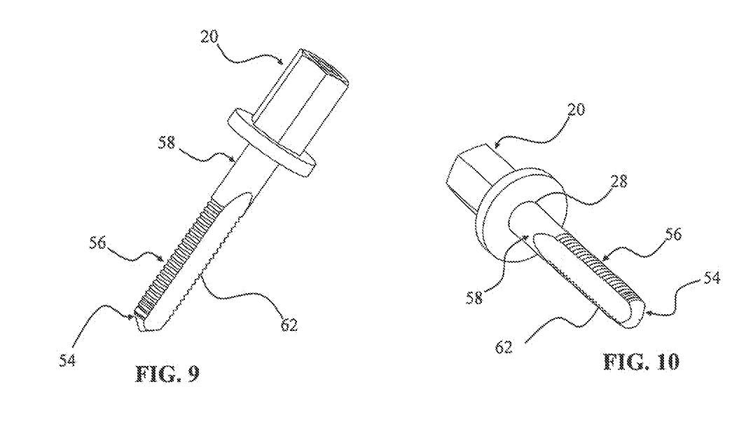

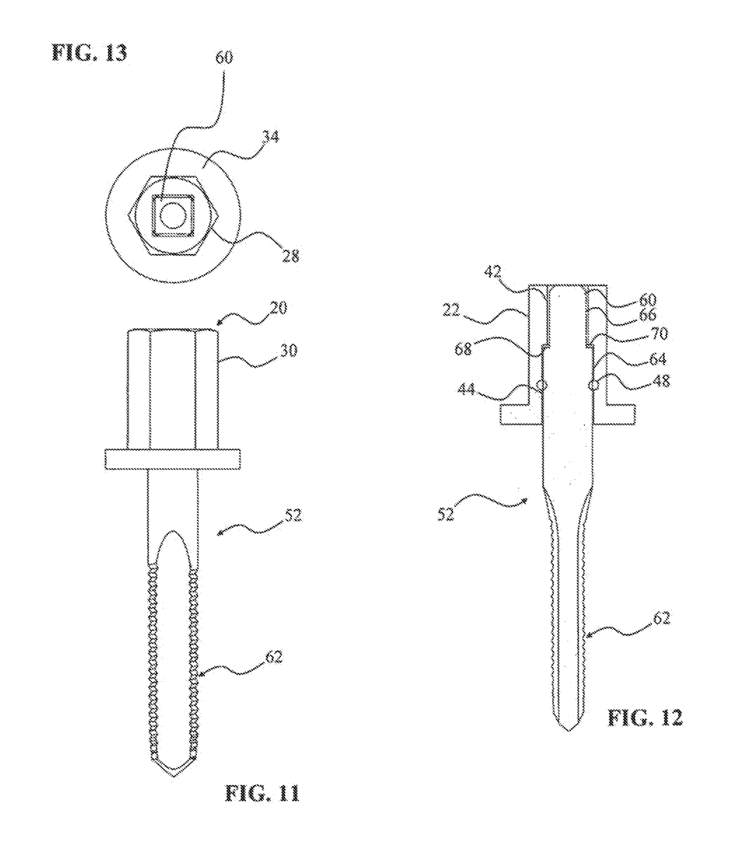

As depicted in FIGS. 9-13, a thread tap 52 for use with a thread tap adapter 20 according to an embodiment of the present invention, generally comprises an elongated tap body 54 having a die portion 56, a shank portion 58 and a multi-faceted drive portion 60 arranged axially on the tap body 54. The die portion 56 comprises a plurality of reverse threads 62 for cutting the appropriate threads in a bore hole. In various embodiments, the depth, density and angle of the reverse threads 62 can be varied to provide conventional thread patterns. As depicted in FIG. 12, the shank portion 58 comprises an exterior shank surface 64 having a generally cylindrical profile. In other embodiments, the shank portion 58 can comprise a hexagonal or other multi-faceted profile. The drive portion 60 comprises a multi-faceted drive surface 66. As depicted in FIG. 12, the multi-faceted drive surface 66 comprises a conventional square profile, but can comprise different conventional profiles including hexagonal and other multi-faceted profiles. The description of the thread tap 52 is not intended to be limiting, but rather assist in the description of the thread tap adapted 20.

As depicted in FIGS. 9 and 10, during assembly, the thread tap 52 is inserted into the central axial bore 28 through the second end 26 of the thread tap adapted 20. Certain thread taps 52 comprise a shank portion 58 having a greater outer diameter then the drive portion 60 to define a shoulder 68. In certain embodiments, the drive receiving portion 42 of the central axial bore 28 comprises a diameter smaller than the diameter of the shank receiving portion 40 to define a shoulder 70 engagable to the shoulder 68 of the thread tap 52 and position the thread tap adapter 20 at the proper axial position on the thread tap 52 as shown in FIG. 12. Upon insertion and proper axial positioning, the drive surface 50 of the central axial bore 28 engages the corresponding facets of the drive surface 66 of the thread tap 52. The interfacing planar facets prevent the thread tap adapter 20 from rotating around the thread tap 52 such that rotation of the thread tap adapter 20 causes the thread tap 52 to rotate. Similarly, in certain embodiments, the inner shank surface 44 of the thread tap adapter 20 engages the exterior shank surface 64 of the thread tap 52. In this configuration, the inner shank surface 44 corresponds to the contours of the exterior shank surface 64.

Similarly, the retention element 46 engages the shank portion 58 of the thread tap 52, wherein the retention element 46 is sized such that the insertion of the thread tap 52 into the central axial bore 28 deforms or otherwise engages the retention element 46 to provide positive engagement or frictional engagement of the shank portion 58 of the thread tap 52. The retention element 46 prevents the thread tap 52 from inadvertently moving axially within the central axial bore 28. In certain embodiments, the inner edge of the retention element 46 is contoured or faceted to correspond to the exterior shank surface 64. In certain embodiments, in which the inner shank surface 44 of the thread tap adapter 20 does not the engage the exterior shank surface 64 of the thread tap 52 the retention element 46 provides a second engagement point between the thread tap 52 and the thread tap adapter 20. The dual engagement points prevent the thread tap adapter 20 from rotating relative to the thread tap 52.

In use, a driving device such as, for example, a box wrench, an open ended wrench, a crescent wrench, socket wrench or motorized drill is operably engaged to the external surface 30 of the adapter body 22, wherein the individual sides 31 allow for capture and engagement of the adapter body 22 by the engagement features of the driving device. The first flange portion 32 is positioned such that the alignment face 34 limits the downward axial travel of the engagement features of the driving device so as to prevent unintentional disengagement of the driving device and the adapter body 22 in the case of the driving device comprising a box, open ended or crescent wrench during operation of the driving device to rotate the adapter body 22. In this manner, the driving device is prevented from slipping down and off the adapter body 22 during application of torque with the driving device. In certain embodiments in which the thread adapter 20 is engaged by sliding the engagement features onto the thread adapter 20 along an axis parallel to the central rotational axis of the thread adapter 20, the first flange portion 32 operates as a stop preventing further axial movement of the driving device when the engagement features are properly aligned with the adapter body 22. In certain embodiments, the second flange portion 36 and opposing alignment face 38 cooperate with the first flange portion 32 to prevent axial movement of the driving device, both downward and upward, during rotation of the thread tap 52 via the thread adapter 20.

While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A thread tap adapter, comprising:
an adapter body having a first end, a second end, a multi-faceted external surface and a central axial bore extending between the first end and the second end, and wherein the adapter body includes a first flange portion proximate the second end, the first flange portion defining a first engagement face.

2. The thread tap adapter of claim 1, wherein the central axial bore define a shank receiving portion proximate the second end and a drive receiving portion proximate the first end.

3. The thread tap adapter of claim 2, wherein the shank receiving portion defines an inner shank surface having a generally cylindrical profile, and wherein a radial groove is present in the inner shank surface, said radial groove having a retention element mounted therein.

4. The thread tap adapter of claim 1, wherein said multi-faceted external surface comprises six individual sides.

5. The adapter of claim 1, wherein said multi-faceted external surface is adapted for engagement with a three-jaw chuck.

6. The thread tap adapter of claim 1, wherein the adapter body further comprises a second flange portion proximate the first end, the second flange portion defining a second engagement face oriented to face the first engagement face.

7. A system for tapping threads in an aperture, comprising:
a thread tap having a die portion, a shank portion and a drive portion, said die portion including a reverse thread;
an adapter body having a first end, a second end, a multi-faceted external surface and a central axial bore extending between the first end and the second end, the central axial bore adapted to engage the thread tap and wherein the adapter body further includes a first flange portion proximate the second end, the first flange portion defining a first engagement face; and
a driving device for engaging the multi-faceted external surface such that rotation of the driving device causes the thread tap to rotate, wherein downward slippage of the driving device relative to the adapter body is prevented through the engagement of the driving device and the first engagement face.

8. The system of claim 7, wherein the central axial bore defines a shank receiving portion proximate the second end and a drive receiving portion proximate the first end and wherein the thread tap is slidably insertable into the central axial bore at the second end such that the drive portion inserts into and engages the drive receiving portion.

9. The system of claim 8, wherein the shank receiving portion has an inner shank surface defining a generally cylindrical profile, the inner shank surface having a radial groove located therein, and wherein a retention element is mounted within the radial groove, said retention element being compressed by the shank portion for retaining the thread tap within the adapter body.

10. The system of claim 7, wherein the driving device is selected from the group consisting essentially of a box wrench, an open-ended wrench, a crescent wrench, and a socket.

11. The system of claim 7, wherein the driving device further comprises a three-jaw chuck, and wherein the three-jaw chuck engages the multi-faceted external surface.

12. The system of claim 7, wherein the adapter body further comprises a second flange portion proximate the first end, the second flange portion defining a second engagement face oriented to face the first engagement face, and wherein upward and downward movement of the driving device relative to the adapter body is prevented through engaging the adapter body with the driving device between the first and second engagement faces.
